(19) United States
(12) Patent Application Publication
(10) Pub. No.: US 2008/0078420 A1
(43) Pub. Date: Apr. 3, 2008

(54) METHOD FOR POST-CMP WAFER SURFACE CLEANING

(75) Inventors: Jing Wen, Shanghai (CN); Shoulong Zhang, Shanghai (CN); Yangbo Li, Shanghai (CN); Jun Lin, Shanghai (CN); Po-Cheng Chiu, Shanghai (CN); Teh-Wei Ger, Shanghai (CN); Paul Chang Lin, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: SEMICONDUCTOR MANUFACTURING INTERNATIONAL (Shanghai) CORPORATION, Shanghai (CN)

(21) Appl. No.: 11/618,654

(22) Filed: Dec. 29, 2006

(30) Foreign Application Priority Data
Sep. 30, 2006 (CN) 200610116851.8

(51) Int. Cl. B08B 3/12

(52) U.S. Cl. 134/1

(57) ABSTRACT

A method for cleaning a wafer after a Chemical Mechanical Polishing (CMP) of the wafer includes: performing an ultrasonic cleaning on the wafer for time T₁; cleaning the wafer with a chemical agent and then with deionized water for n times for time T₂, T₃, . . . , Tₙ₊₁, respectively, n being an integer; drying the wafer for time Tₙ₊₂; wherein the maximum value among T₂, T₃, . . . , Tₙ₊₂ is Tₘₐₓ, where in the case of T₁<Tₘₐₓ, the ultrasonic cleaning process includes: loading the wafer in an ultrasonic cleaning module and holding the wafer without the application of ultrasonic power for T′, with T′=Tₘₐₓ−T₁; and then performing the ultrasonic cleaning on the wafer for time T₁. The method proceeds with the next cleaning process immediately after the ultrasonic cleaning is completed. The method may completely remove defect particles on post-CMP wafer surfaces and improve the yield by 3%.

This application claims the priority of Chinese Patent Application No. 200610116851.8, filed Sep. 30, 2006, the entire disclosure of which is incorporated herein by reference.

### FIELD OF THE INVENTION

The present invention relates to a semiconductor device cleaning method, and in particular to a method for post-Chemical Mechanical Polishing (post-CMP) semiconductor device cleaning.

### BACKGROUND OF THE INVENTION

In general, in the manufacturing of semiconductor devices from a wafer, unevenness often occurs on the surface of the wafer which is in a laminated structure. Such an uneven surface is flattened usually by means of a Chemical Mechanical Polishing (CMP) process in the prior art.

The Chemical Mechanical Polishing process is generally carried out with a CMP apparatus, and a solution containing compact polishing particles (e.g., silicon dioxide particles or aluminum oxide particles) is used to polish the wafer during the CMP process. After the CMP process, those polishing particles become defect particles and must be removed from the wafer surface, so as to maintain the reliability of the electronic devices and the cleanness of the product line.

A common method for removing defect particles on the wafer surface after CMP is to clean the wafer with a chemical cleaning solution and deionized water, optionally in conjunction with a scrubbing process. For example, Chinese Patent application No. 98810443 discloses a method for cleaning semiconductor substrate after polishing a copper film by a CMP process, in which the substrate is scrubbed with a brush and then cleaned with a solution with pH<7 mixed with deionized water, an organic acid and fluoride. However, in semiconductor manufacturing processes smaller than 0.18 um, especially in 0.13 um and 90 nm processes, defect particles are more prone to be stuck between devices because the devices have smaller sizes and are distributed in higher density, which makes it difficult to remove those particles. Therefore, there is a need for more advanced cleaning apparatuses and processes. Presently, the defect particles stuck between components and to wafer surface are usually removed by ultrasonic cleaning.

In a semiconductor manufacturing process smaller than 0.18 um, for example, in a tungsten plug fabricating process, as shown in FIG. 1, a semiconductor substrate 10 is provided, which, for example, has an underlying metal layer 12 (e.g., aluminum layer). A dielectric layer 14, which consists of silicon dioxide, is formed to cover the substrate structure. The dielectric layer 14 is patterned to form an opening 16, exposing the underlying metal layer 12. Then, as shown in FIG. 2, an adhesion layer 18 is formed to cover the underlying metal layer 12 and the side walls of the dielectric layer 14 exposed in the opening 16 as well as a surface of the dielectric layer 14. The adhesion layer 18 consists of a material such as titanium/titanium nitride. Next, the plug material 20 (e.g., tungsten) is deposited to cover the adhesion layer 18. Finally, as shown in FIG. 3, the plug material 20 is polished by a CMP process to expose the dielectric layer 14 and form the plug 21.

The polishing chemical agent used during polishing of the plug material 20 by means of the CMP process to expose the dielectric layer 14 contains silicon dioxide particles. After the CMP process, the defect particles (e.g., silicon dioxide particles) in the polishing chemical agent may adhere between tungsten plugs or to the wafer surface, and have to be removed with an ultrasonic cleaning apparatus. A common ultrasonic cleaning process usually includes the following procedures: the wafer is cleaned by ultrasonic cleaning in a solution containing a cleaning chemical agent; the residual cleaning chemical agent on the wafer surface is removed by cleaning with deionized water or by cleaning with deionized water in conjunction with scrubbing; and then the wafer is dried.

In an automatic ultrasonic cleaning apparatus, the procedures of ultrasonic cleaning, deionized water cleaning and drying are performed in the same cleaning apparatus according to the specification for cleaning flow. Due to the fact that some cleaning processes have to be performed more than once, for example, the deionized water cleaning process has to be performed more than once to completely remove the cleaning chemical agent adhering to the wafer in the ultrasonic cleaning process, the cleaning apparatus includes three or more cleaning modules. The cleaning modules may be cleaning tanks with brushes or cleaning tanks with introduced cleaning solution. During the cleaning process, there is a wafer being cleaned in each of the cleaning modules. After a cleaning process in a cleaning module is completed for a wafer, the next cleaning process will be performed on the wafer.

In the prior art, a cleaning time is preset for each cleaning module. If the cleaning time set for ultrasonic cleaning is shorter than the cleaning time set for any other cleaning processes or the drying process, it is found that there are still defect particles on the wafer surface after cleaning, resulting in a degraded yield of products.

### SUMMARY OF THE INVENTION

The embodiments of the present invention aim to solve the problem that there are still defect particles on the surface of a wafer after the wafer is cleaned by means of a multi-process ultrasonic cleaning module.

In view of this, in an aspect of the present invention, there is provided a method for cleaning the surface of a wafer after a Chemical Mechanical Polishing (CMP) of the wafer. The method includes: performing an ultrasonic cleaning on the wafer for time T₁; cleaning the wafer with a chemical agent and then with deionized water for n times for time T₂, T₃, . . . , Tₙ₊₁, respectively, with n being an integer; drying the wafer for time Tₙ₊₂; wherein supposing the maximum value among T₂, T₃, . . . , Tₙ₊₂ is Tₘₐₓ, in the case that T₁<Tₘₐₓ, the ultrasonic cleaning process comprises the following:

loading the wafer in an ultrasonic cleaning module, and holding the wafer static and ultrasonic no power for T′, where T′=Tₘₐₓ−T₁; and

performing ultrasonic cleaning on the wafer for time T₁.

Optionally, n is equal to or less than 3.

Optionally, the values of time T₂, T₃, . . . , Tₙ₊₁ for cleaning with the chemical agent and then with the deionized water are between 5 seconds to 110 seconds.

Optionally, the time for cleaning with the chemical agent is between 0 seconds to 70 seconds, and the time for the cleaning with the deionized water is between 5 seconds to 40 seconds.

Optionally, the time T₁ for the ultrasonic cleaning is between 10 seconds to 60 seconds.

Optionally, the time Tₙ₊₂ for the drying is between 5 seconds to 20 seconds.

Optionally, the drying process is performed at 20-40° C.

In another aspect of the present invention, there is provided a method for cleaning the surface of a wafer after a Chemical Mechanical Polishing (CMP) of the wafer. The method includes: performing an ultrasonic cleaning on the wafer for time T₁; scrubbing the wafer for n times for time T₂, T₃, . . . , Tₙ₊₁, respectively, with n being an integer; drying the wafer for time Tₙ₊₂; wherein supposing the maximum value among T₂, T₃, . . . , Tₙ₊₂ is Tₘₐₓ, in the case that T₁<Tₘₐₓ, the ultrasonic cleaning process comprises the following:

loading the wafer in an ultrasonic cleaning module and holding the wafer static and ultrasonic no power for T′, with T′=Tₘₐₓ−T₁; and

performing ultrasonic cleaning on the wafer for time T₁.

Optionally, n is equal to or less than 3.

Optionally, values of time T₂, T₃, . . . , Tₙ₊₁ for scrubbing are between 5 seconds to 110 seconds.

Optionally, the scrubbing of the wafer is assisted with a chemical agent and deionized water.

Optionally, the wafer is scrubbed with the assistance of the chemical agent cleaning for a period between 0 seconds to 70 seconds, and then is scrubbed with the assistance of the deionized water cleaning for a period between 5 seconds to 40 seconds.

Optionally, the time T₁ for the ultrasonic cleaning is between 10 seconds to 60 seconds.

Optionally, the time Tₙ₊₂ for the drying is between 5 seconds to 20 seconds.

Optionally, the drying process is performed at 20-40° C.

Compared with the prior art, the embodiments of the present invention have the following advantages. The embodiments of the present invention provide an improved method for cleaning the surface of a wafer after CMP. In the embodiments of the present invention, the wafer is held static and no ultrasonic is provided in an ultrasonic cleaning module for a period, and the method proceeds with the next cleaning process immediately after the ultrasonic cleaning on the wafer is completed. In this way, the method according to the embodiments of the present invention prevents the defect particles from adhering to the wafer surface again during the time that the wafer is held in the ultrasonic cleaning module after the ultrasonic cleaning on the wafer is completed, and may completely remove the defect particles on the post-CMP wafer surfaces and improve the yield by 3%.

### BRIEF DESCRIPTION OF THE DRAWINGS

FIGS. 1 to 3 are cross-sectional views of a tungsten plug forming process in the prior art;

FIG. 4 is a Scanning Electronic Microscopy (SEM) photo of a wafer with defect particles on its surface after the wafer is cleaned in the prior art;

FIG. 5 is an Energy Dispersive X-ray (EDX) diagram of defect particles on a wafer surface after the wafer is cleaned in the prior art;

FIG. 6 is a process flow diagram according to a first embodiment of the present invention;

FIG. 7 is a process flow diagram according to a second embodiment of the present invention;

FIG. 8 is a process flow diagram according to a third embodiment of the present invention;

FIG. 9 is a process flow diagram according to a fourth embodiment of the present invention;

FIG. 10 shows defect particles on a wafer surface in a cleaning method according to an embodiment of the present invention versus that in a cleaning method in the prior art;

FIG. 11 shows the yields of different batches of wafers which are cleaned by the cleaning process according to an embodiment of the present invention after being treated with a CMP process to polish tungsten plugs versus the yields of different batches of wafers which are cleaned by the cleaning process in the prior art after being treated with an CMP process to polish tungsten plugs;

FIG. 12 shows the numbers of defects on the surfaces of wafers which are cleaned in different periods by the cleaning process according to an embodiment of the present invention after being treated with a CMP process to polish tungsten plugs versus the numbers of defects on surfaces of wafers which are cleaned in different periods by the cleaning process in the prior art after being treated with an CMP process to polish tungsten plugs.

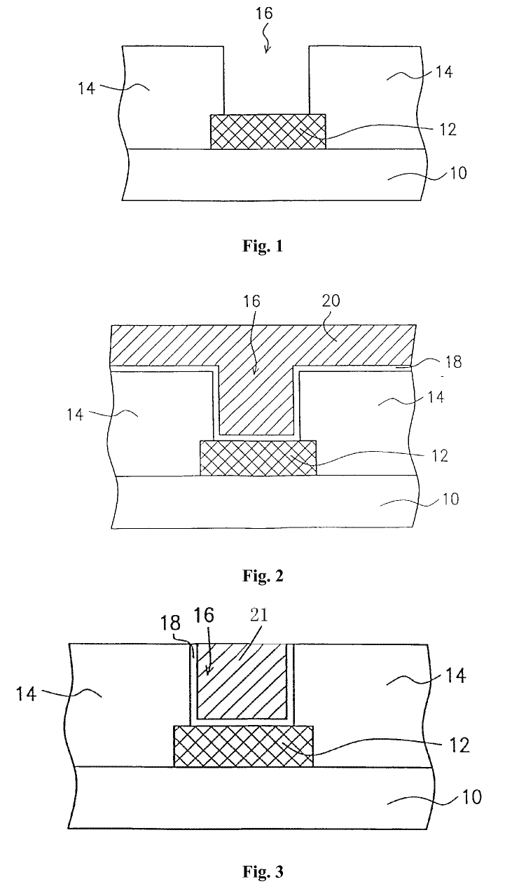

### DETAILED DESCRIPTION OF THE EMBODIMENTS

Embodiments of the present invention will be described in detail with reference to accompanying drawings.

In the prior art, for example, an ultrasonic cleaning apparatus has an ultrasonic cleaning module, two scrubbing modules which are both assisted with a deionized water cleaning means and a chemical agent cleaning means respectively, and a drying module. In the cleaning process, there is a wafer in each of the modules. Supposing the time of ultrasonic cleaning in the ultrasonic cleaning module is 30 s, and the time of cleaning in the scrubbing module adjacent to the ultrasonic cleaning module is set to 60 s. Once a wafer with defect particles on its surface is loaded into the ultrasonic cleaning module, the ultrasonic cleaning begins immediately. After 30 s, the ultrasonic cleaning is completed. However, there is another wafer being scrubbed in the scrubbing module adjacent to the ultrasonic cleaning module. Since the heater in the ultrasonic cleaning module has a very short service life and may be damaged easily if it operates continuously for a long time, usually the wafer is held for 30 s in the ultrasonic cleaning module so as to prolong the service life of the ultrasonic cleaning module; only when the scrubbing of the wafer in the scrubbing module adjacent to the ultrasonic cleaning module is completed, the wafer in the ultrasonic cleaning module may be transferred to the scrubbing module and is placed into the scrubbing process. Then, the scrubbing and drying processes are implemented in the preset cleaning sequence and times.

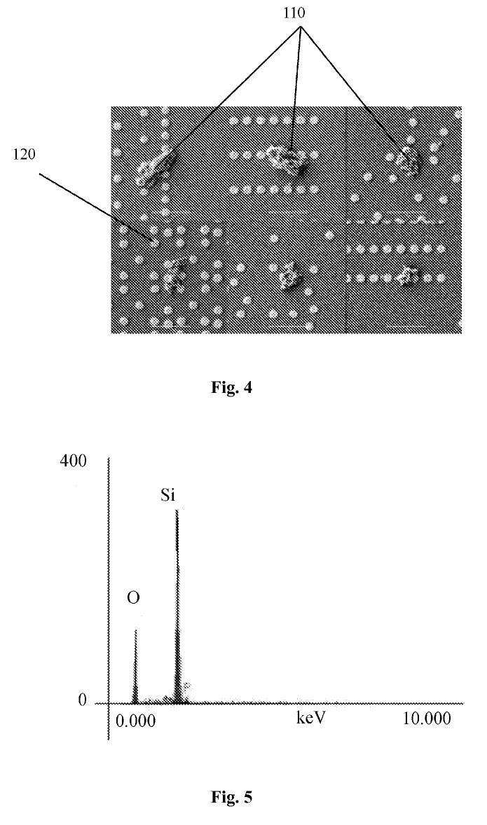

However, after the wafers are cleaned and dried with the method in the prior art, it is found that there may still be defect particles on wafer surfaces. FIG. 4 shows an SEM photo of the surface of a wafer cleaned with the method in the prior art after the tungsten plug material is polished by means of a CMP solution with silicon dioxide particles to form tungsten plugs. As shown, there are many defect particles 110 on the tungsten plugs 120 and the wafer. Those defect particles existing after cleaning decrease the yield of semiconductor devices by 2%-3%. After an EDX analysis of the defect particles 110 shown in FIG. 4, it is found that the major components of the defect particles are silicon and oxygen, as shown in the EDX diagram in FIG. 5.

Through further investigation, it is found that the defect particles existing on the surface of a wafer after the cleaning process in the prior art are adhered to the wafer surface again during the time the wafer is held in the ultrasonic cleaning module after ultrasonic cleaning. This is because there are defect particles removed from wafers in the ultrasonic cleaning module after those wafers are cleaned in the ultrasonic cleaning module. During the time the wafer is held in the ultrasonic cleaning module after ultrasonic cleaning, some defect particles will adhere to the wafer surface again.

Therefore, some embodiments of the present invention provides a method for cleaning the surface of a wafer after a Chemical Mechanical Polishing (CMP) of the wafer. The method includes the following processes: performing an ultrasonic cleaning on the wafer for time T₁; cleaning with a chemical agent and deionized water for n times for time T₂, T₃, . . . , Tₙ₊₁, respectively, with n being a an integer; drying the wafer for time Tₙ₊₂; supposing the maximum value among T₂, T₃, . . . , Tₙ₊₂ is Tₘₐₓ, in the case that T₁<Tₘₐₓ, the ultrasonic cleaning process includes the following procedures: loading a wafer into an ultrasonic cleaning module and holding the wafer static and ultrasonic no power for time T′ (T′=Tₘₐₓ−T₁); cleaning the wafer by the ultrasonic cleaning for time T₁; after the ultrasonic cleaning, cleaning the wafer with the chemical agent and deionized water immediately.

It is undoubtedly that the bigger the “n” value is (i.e., the more the cleaning times are), the fewer the number of residual defect particles on the wafer surface after cleaning will be, and the higher the yield will be. However, in the industrial manufacturing process, in view of the requirement for process time and cost, “n” is preferably an integer≦3 in the embodiments of the invention, and more preferably n=2; for some wafers that have achieved better cleaning result in the ultrasonic cleaning process, preferably n=1. In some of the embodiments described below, n is equal to 1 or 2.

### Embodiment 1

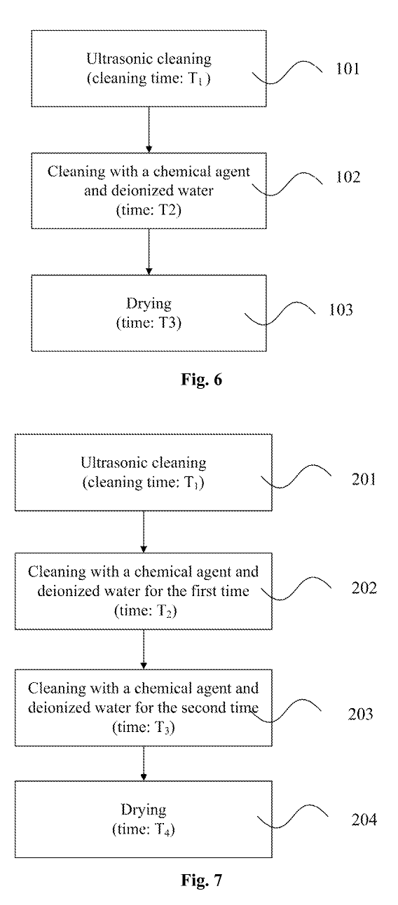

As shown in FIG. 6, in this embodiment, n=1. The method for cleaning the surface of a wafer after a Chemical Mechanical Polishing (CMP) of the wafer according to the embodiment includes the following processes: Step 101: performing an ultrasonic cleaning on the wafer for time T₁; Step 102: cleaning the wafer with a chemical agent and deionized water for time T₂; Step 103: drying the wafer for time T₃; in the case that T₁<T₂ or T₁<T₃, the ultrasonic cleaning process includes the following procedures: loading the wafer into a ultrasonic cleaning module and holding the wafer without the application of ultrasonic power for time T′ (T′ is equal to the difference between T₁ and the larger of T₂ and T₃; then, performing the ultrasonic cleaning for time T₁; next, transferring the wafer immediately into a deionized water and chemical agent cleaning module, to prevent the defect particles in the ultrasonic cleaning module from contaminating the wafer surface again during the time the wafer is held in the ultrasonic cleaning module.

In order to remove the defect particles on the wafer surface or inlaid in the wafer in the ultrasonic cleaning process, the ultrasonic cleaning module contains a chemical agent, which is chosen depending on the polishing solution used in the CMP process. For example, if the polishing solution contains silicon dioxide particles, usually a chemical agent containing ammonia is chosen for cleaning. The time T₁ of ultrasonic cleaning may be set to 10 s-60 s, and preferably 35 s-45 s.

After the ultrasonic cleaning, the wafer is loaded into the deionized water and chemical agent cleaning module immediately; the time T₂ of cleaning with a chemical agent and deionized water is set to 5 s-110 s, and preferably 20 s-90 s, in which the time of cleaning with chemical agent is 0 s-70 s, and the time of cleaning with the deionized water is 5 s-40 s. In the case that almost all defect particles on the wafer surface are removed after the ultrasonic cleaning, the wafer then may be cleaned merely with the deionized water; in that case, the time of cleaning with the chemical agent is 0. If there are defect particles on the wafer surface which cannot be removed by the ultrasonic cleaning, the wafer should be cleaned with the chemical agent first in the subsequent cleaning processes. The chemical agent may be chosen depending on the category and characteristic of the defect particles existing on the wafer surface. For example, if the defect particles existing on the wafer surface have negative charges, the chosen chemical agent should contain positive charges so as to remove the defect particles existing on the wafer surface by chemical cleaning. After the chemical cleaning, the chemical agent on the wafer surface is removed with pure deionized water in the same deionized water and chemical agent cleaning module. Next, the wafer is baked in the drying module for 5 s-20 s at 20° C.-40° C. to remove the moisture on the wafer surface.

Now a complete embodiment is described. A first wafer is loaded into an ultrasonic cleaning module and held with the application of ultrasonic power for 55 s. Then the ultrasonic cleaning module is started and cleans the wafer for 35 s; next, the first wafer is transferred to a deionized water and chemical agent cleaning module immediately and cleaned for a total of 90 s with a chemical agent and deionized water, in which the time of cleaning with the chemical agent is 60 s, and the time of cleaning with the deionized water is 30 s. Next, the first wafer is transferred to a drying module and baked for 20 s at 20° C. Subsequently, the first wafer is taken out from the drying module. After the first wafer is transferred to the deionized water and chemical agent cleaning module, a second wafer is loaded into the ultrasonic cleaning module, and similarly, the second wafer is held without the application of ultrasonic power in the ultrasonic cleaning module for 55 s. Then the ultrasonic cleaning module is started and cleans the second wafer for 35 s. Due to the fact that the first wafer stays in the deionized water and chemical agent cleaning module is 90 s, the second wafer may be transferred into the deionized water and chemical agent cleaning module immediately after the second wafer is cleaned in the ultrasonic cleaning module. The second wafer may be transferred into the drying module when the cleaning of the second wafer is completed, since the first wafer has been taken out from the drying module at that time. Through the above processes, multiple wafers may be cleaned in succession. In addition, those processes avoid the procedure that a wafer is held in the ultrasonic cleaning module for a period after the ultrasonic cleaning, and thereby prevent the defect particles in the ultrasonic cleaning module from contaminating the surface of the wafer again.

### Embodiment 2

As shown in FIG. 7, in this embodiment, n=2. The method for cleaning the surface of a wafer after a Chemical Mechanical Polishing (CMP) of the wafer according to the embodiment includes the following processes: Step 201: performing an ultrasonic cleaning on the wafer for time T₁; Step 202: cleaning the wafer with a chemical agent and deionized water for the first time for time T₂; Step 203: cleaning the wafer with the chemical agent and deionized water for the second time for time T₃; Step 204: drying the wafer for time T₄; in the case that T₁<T₂ or T₁<T₃ or T₁<T₄, the ultrasonic cleaning process includes the following procedures: loading the wafer into an ultrasonic cleaning module and holding the wafer without the application of ultrasonic power for T′ (T′ is equal to the difference between T₁ and the larger of T₂ and T₃); performing the ultrasonic cleaning on the wafer for time T₁; after the ultrasonic cleaning, transferring the wafer into a deionized water and chemical agent cleaning module immediately, to prevent defect particles in the ultrasonic cleaning module from contaminating the surface of the wafer again during the time that the wafer stays in the ultrasonic cleaning module.

The time T₁ of ultrasonic cleaning is set to 10 s-60 s, and preferably 35 s-45 s. The chemical agent used in the ultrasonic cleaning is chosen according to the same principle as that used in Embodiment 1. The time of cleaning with the chemical agent and the deionized water for the first time is set to 5 s-110 s, and preferably 20 s-90 s, in which the time of cleaning with the chemical agent is 0 s-70 s and the time of cleaning with the deionized water is 5 s-40 s. The cleaning chemical agent and the cleaning time for the cleaning process with the chemical agent are chosen in the same way as that in Embodiment 1.

In order to achieve better cleaning effect and remove the defect particles still adhering to the wafer surface after the wafer is cleaned with the chemical agent and deionized water for the first time, the cleaning with chemical agent and deionized water is performed for the second time for time T₄. The time T₄ is 5 s-110 s and preferably 20 s-90 s, in which the time of cleaning with chemical agent is 0 s-70 s and the time of cleaning with deionized water is 5 s-40 s. The chemical agent should be chosen also depending on the category and amount of defect particles on the wafer surface. For example, if the defect particles on the wafer surface are alkaline particles, an acidic chemical agent with pH<7 is chosen as the cleaning chemical agent. After cleaning with the chemical agent, the residual acidic chemical agent on the wafer surface is removed with the deionized water. Next, the wafer is dried by baking for 5 s-20 s at 20° C.-40° C., so as to remove moisture on the wafer surface.

Now a complete embodiment is described. First, a first wafer is loaded into an ultrasonic cleaning module and held without application of ultrasonic power for 20 s. Then, the ultrasonic cleaning module is started and cleans the wafer for 40 s. Next, the wafer is transferred to a first deionized water and chemical agent cleaning module immediately and cleaned for total 50 s, in witch the time of cleaning with a chemical agent is 20 s and the time of cleaning with deionized water is 30 s. Afterwards, the wafer is transferred into a second deionized water and chemical agent cleaning module and cleaned for the second time for 60 s in which the time of cleaning with the chemical agent is 40 s and the time of cleaning with the deionized water is 20 s. Then, the wafer is transferred to a drying module and baked for 10 s at 30° C.; then, the wafer is taken out from the drying module. After the first wafer is transferred to the first deionized water and chemical agent cleaning module, the second wafer is loaded into the ultrasonic cleaning module. Similar to the treatment on the first wafer, the second wafer is held static and ultrasonic is held no power for 20 s first, and then the ultrasonic cleaning module is started and cleans the second wafer for 40 s. Since the first wafer stays in the first deionized water and chemical agent cleaning module for 50 s, the second wafer may be transferred to the first deionized water and chemical agent cleaning module immediately after being cleaned in the ultrasonic cleaning module. At that time the first wafer has been transferred into the second deionized water and chemical agent cleaning module, and a third wafer is loaded into the ultrasonic cleaning module, and so on. With the technical scheme provided in the embodiment of the present invention, any wafer will not stay in the ultrasonic cleaning module after being cleaned in the ultrasonic cleaning module. Therefore, the technical scheme may prevent the defect particles in the ultrasonic cleaning module from contaminating the surface of the wafer again.

In accordance with another aspect of the present invention, after being subjected to ultrasonic cleaning, defect particles adhering to a wafer surface or inlaid between semiconductor structures such as tungsten plugs cannot be removed completely merely with deionized water or a chemical agent, and they have to be further cleaned with a brush. Therefore, in an embodiment of the present invention, there is also provided a method for cleaning the surface of a wafer after a Chemical Mechanical Polishing (CMP) of the wafer. The method includes the following processes: performing an ultrasonic cleaning on the wafer for time T₁; scrubbing the wafer for n times for time T₂, T₃, . . . , Tₙ₊₁ (“n” is an integer), respectively; drying the wafer for time Tₙ₊₂; suppose the maximum value among T₂, T₃, . . . , Tₙ₊₂ is Tₘₐₓ, in the case that T₁ is less than any one of T₂, T₃, . . . , Tₙ₊₂, the ultrasonic cleaning process includes the following procedures: loading the wafer into an ultrasonic cleaning module and holding the wafer without the application of ultrasonic power for T′ (T′=Tₘₐₓ−T₁); performing the ultrasonic cleaning on the wafer for time T₁; after the ultrasonic cleaning, scrubbing the wafer immediately. The ultrasonic cleaning is performed for time T1, and the scrubbing is performed for n times for time T₂, T₃, . . . , Tₙ₊₁ (“n” is an integer) with the assist of a chemical agent and deionized water cleaning; drying for time Tₙ₊₂.S supposing the maximum value among T₂, T₃, . . . , Tₙ₊₂ is Tₘₐₓ, in the case that T₁<Tₘₐₓ, the ultrasonic cleaning process includes the following procedures: loading the wafer into the ultrasonic cleaning module and holding the wafer without the application of ultrasonic power for time T′ (T′=Tₘₐₓ−T₁); performing the ultrasonic cleaning on the wafer for T₁, and then scrubbing the wafer immediately.

### Embodiment 3

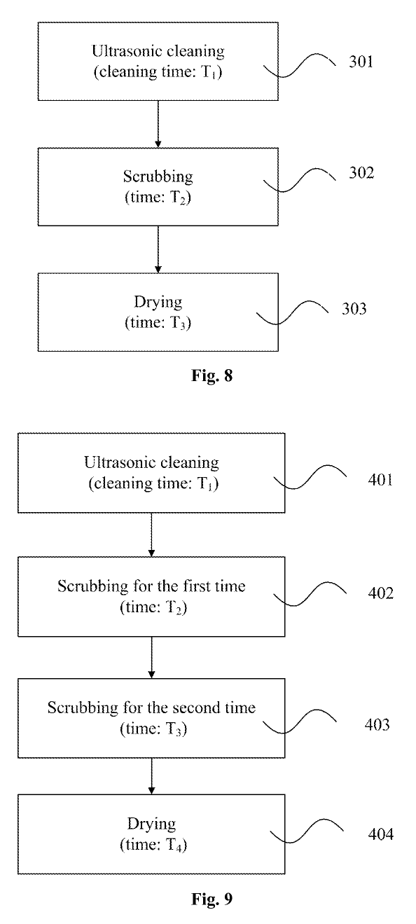

As shown in FIG. 8, in this embodiment, n=1. A method for cleaning the surface of a wafer after a Chemical Mechanical Polishing (CMP) of the wafer according to the embodiment includes the following processes: Step 301: performing a ultrasonic cleaning on the wafer for time T₁; Step 302: scrubbing the wafer for time T₂ (during the semiconductor manufacturing, the scrubbing process is adapted to remove defect particles which still adhere to the wafer surface or are inlaid between semiconductor structures such as tungsten plugs after the ultrasonic cleaning, and the scrubbing process is usually assisted with a chemical agent and deionized water cleaning, in order to achieve better cleaning effect); Step 303: drying the wafer for time T₃. In the case of T₁<T₂ or T₁<T₃, the ultrasonic cleaning process includes the following procedures: loading the wafer in a ultrasonic cleaning module and holding the wafer without the application of ultrasonic power for time T′ (T′ is equal to the difference between T₁ and the larger of T₂ and T₃); next, performing the ultrasonic cleaning for time T₁; and then, transferring the wafer into a cleaning module with a brush, a chemical agent cleaning means and a deionized water cleaning means immediately. During the scrubbing, the wafer is cleaned with the assistance of the chemical agent and the deionized water so as to remove any defect particle still adhering to the wafer surface or inlaid between the tungsten plugs after the ultrasonic cleaning, and the brush is also cleaned with the assistance of the chemical agent and the deionized water.

In this embodiment, the time T₁ of ultrasonic cleaning is set to 10 s-60 s, and preferably 35 s-45 s. After the ultrasonic cleaning, the wafer is transferred into the scrubbing module. The time T₂ of scrubbing is set to 5 s-110 s, and preferably 20 s-90 s. At the beginning of scrubbing, a chemical agent is chosen depending on the category and amount of the defect particles on the wafer surface. After being cleaned with the chemical agent for 0 s-70 s, the wafer is cleaned with the deionized water for 5 s-40 s till the entire scrubbing process is completed. The chemical agent is chosen according to the same principle as that used in Embodiment 1. Next, the wafer is dried by baking it for 5 s-20 s at 20° C.-40° C. so as to remove moisture on the wafer surface.

In a preferred embodiment, a wafer is held without the application of ultrasonic power in an ultrasonic cleaning module for 35 s; then, the wafer is cleaned by ultrasonic cleaning for time T₁=45 s; next, the wafer is scrubbed with the assistance of a chemical agent and deionized water cleaning for time T₂=80 s, in which the time of chemical agent cleaning is 50 s and the time of deionized water cleaning is 30 s. After the cleanings, the wafer is dried for 5 s at 40° C. to remove moisture on the surface of the wafer.

### Embodiment 4

As shown in FIG. 9, in this embodiment, n=2. A method for cleaning the surface of a wafer after a Chemical Mechanical Polishing (CMP) of the wafer according to the embodiment includes the following processes: Step 401: performing an ultrasonic cleaning on the wafer for time T₁; Step 402: scrubbing the wafer for the first time with the assistance of a of a chemical agent and deionized water for time T₂; Step 403: scrubbing the wafer for the second time with the assistance of the chemical agent and deionized water for time T₃; Step 404: drying the wafer for time T₄. In the case of T₁<T₂ or T₁<T₃ or T₁<T₄, the ultrasonic cleaning process includes the following procedures: loading the wafer in an ultrasonic cleaning module and holding the wafer without the application of ultrasonic power for time T′ (T′ is equal to the difference between T₁ and the larger of T₂ and T₃); next, performing the ultrasonic cleaning on the wafer for T₁; immediately transferring the wafer into a scrubbing module for the first scrubbing, so as to prevent the defect particles in the ultrasonic cleaning module from settling on the wafer surface again when the wafer is held in the ultrasonic cleaning module.

In Embodiment 4, the time T₁ of ultrasonic cleaning is set to 10 s-60 s, and preferably 35 s-45 s. After the ultrasonic cleaning, the wafer is transferred into the scrubbing module. The time T₂ of scrubbing is set to 5 s-110 s, and preferably 20 s-90 s. At the beginning of the scrubbing, the chemical agent is chosen depending on the category and amount of the defect particles on the wafer surface. After being cleaned with the chemical agent for 0 s-70 s, the wafer is cleaned with the deionized water for 5 s-40 s till the entire scrubbing process is completed. The chemical agent is chosen according to the same principle as that used in Embodiment 1. Next, the scrubbing is performed for the second time. At the beginning of the scrubbing, the chemical agent is chosen depending on the category and amount of the residual defect particles on the wafer surface. After being cleaned with the chemical agent for 0 s-70 s, the wafer is cleaned with the deionized water for 5 s-40 s. Finally, the wafer is dried by being baked for 5 s-20 s at 20° C.-40° C., in order to remove moisture on the wafer surface.

In a preferred embodiment, a wafer is held without the application of ultrasonic power in an ultrasonic cleaning module for 25 s. Then, the wafer is cleaned with ultrasonic cleaning for time T₁=25 s. Next, the wafer is scrubbed for the first time with the assist of a chemical agent and deionized water cleaning for time T₂=50 s, in which the time of cleaning with chemical agent is 10 s and the time of cleaning with deionized water is 40 s. Subsequently, the wafer is scrubbed for the second time with the assistance of a chemical agent or deionized water cleaning for T₃=40 s, in which the time of cleaning with chemical agent is 15 s and the time of cleaning with deionized water is 25 s. After the cleaning, the wafer is dried by being baked for 15 s at 25° C., in order to remove moisture on the wafer surface.

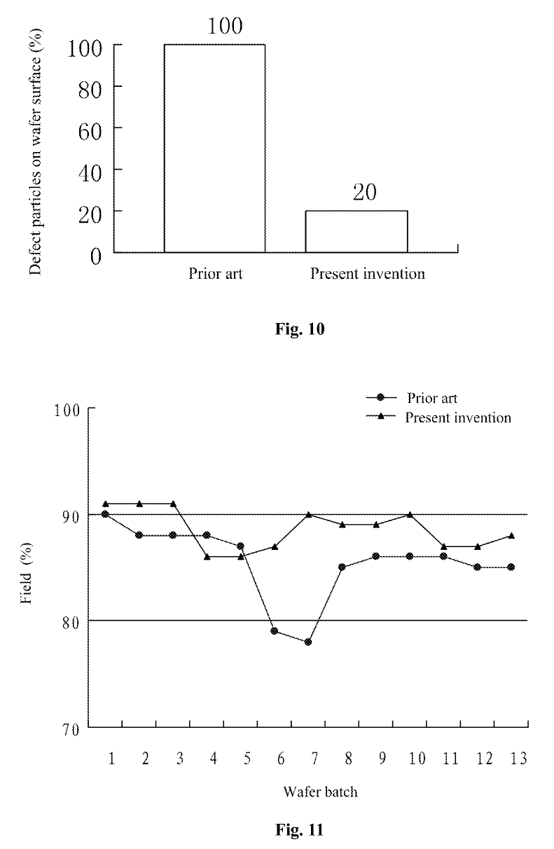

With any of the technical schemes in the above embodiments 1-4, the residual defect particles on a wafer surface or between semiconductor devices and structures after CMP may be removed effectively. Specific effects are shown in FIGS. 10-12.

FIG. 10 shows the defect particles on the surface of a wafer which is cleaned by a cleaning method according to an embodiment of the present invention after being treated with a CMP process to polish tungsten plugs versus the defect particles on the surface of a wafer which is cleaned by a cleaning method in the prior art after being treated with a CMP process to polish tungsten plugs. It is seen from FIG. 10 that supposing the percentage of residual defect particles on the wafer surface after cleaning with the method in the prior art is 100%, the percentage of residual defect particles on wafer surface after cleaning with the method according to the embodiment of the present invention is 20% (reduced by 80%), compared to the method in the prior art.

FIG. 11 shows the yields of different batches of wafers which are cleaned by the cleaning process according to an embodiment of the present invention after being treated with a CMP process to polish tungsten plugs versus the yields of different batches of wafers which are cleaned by the cleaning process in the prior art after being treated with a CMP process to polish tungsten plugs. It is seen from FIG. 11 that, with the method for post-CMP wafer cleaning according to the embodiment of the present invention, the average yield is improved from 85.46% to 88.62%, an increase of 3.2%.

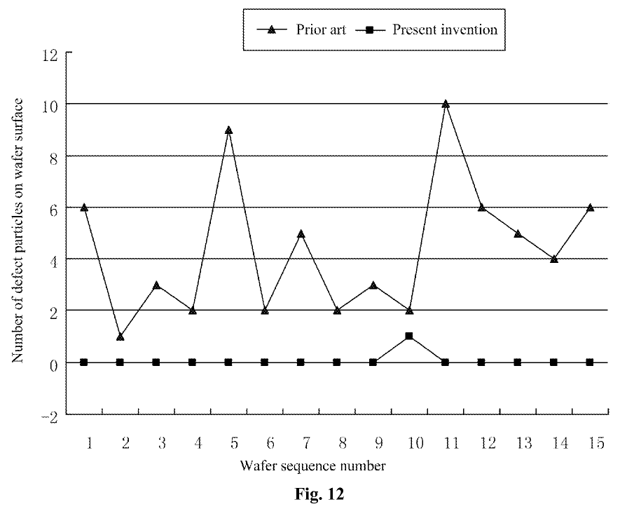

FIG. 12 shows the numbers of defects on the surfaces of wafers which are cleaned in different periods by the cleaning process according to an embodiment of the present invention after being treated with a CMP process to polish tungsten plugs versus the numbers of defects on the surfaces of wafers which are cleaned in different periods by the cleaning process in the prior art after being treated with an CMP process to polish tungsten plugs. It is seen from FIG. 12 that the numbers of defect particles on the wafer surfaces are reduced greatly. Furthermore, with the cleaning method according to the embodiment of the present invention, the average number of defect particles on the wafer surfaces after being cleaned is approximately 0.

Though the present invention is described above in preferred embodiments, it is noted that those skilled in the art may make modifications and variations, without departing from the basic principle of the present invention; any of those modifications and variations shall fall into the protected scope of the present invention defined by the following claims.

What is claimed is:

1. A method for cleaning a wafer after a Chemical Mechanical Polishing (CMP) of the wafer, comprising: performing an ultrasonic cleaning on the wafer for time T₁; cleaning the wafer with a chemical agent and then with deionized water for n times for time T₂, T₃, . . . , Tₙ₊₁, respectively, with n being an integer; drying the wafer for time Tₙ₊₂; wherein the maximum value among T₂, T₃, . . . , Tₙ₊₂ is Tₘₐₓ, wherein in the case of T₁<Tₘₐₓ, the ultrasonic cleaning step comprises the following:
loading the wafer in an ultrasonic cleaning module and holding the wafer without the application of ultrasonic power for T′, with T′=Tₘₐₓ−T₁; and
then performing the ultrasonic cleaning on the wafer for time T₁.

2. The method according to claim 1, wherein the n is equal to or less than 3.

3. The method according to claim 1, wherein the values of time T₂, T₃, . . . , Tₙ₊₁ for cleaning with the chemical agent and for cleaning with the deionized water are between 5 seconds to 110 seconds.

4. The method according to claim 3, wherein the time the cleaning with the chemical agent is between 0 seconds to 70 seconds, and the time for cleaning with the deionized water is between 5 seconds to 40 seconds.

5. The method according to claim 1, wherein the time T₁ for ultrasonic cleaning is between 10 seconds to 60 seconds.

6. The method according to claim 1, wherein the time Tₙ₊₂ for drying is between 5 seconds to 20 seconds.

7. The method according to claim 1, wherein the drying process is performed at 20-40° C.

8. The method according to claim 2, wherein the values of time T₂, T₃, . . . , Tₙ₊₁ for cleaning with the chemical agent and cleaning with the deionized water are between 5 seconds to 110 seconds.

9. The method according to claim 8, wherein the time for cleaning with the chemical agent is between 0 seconds to 70 seconds, and the time for cleaning with the deionized water is between 5 seconds to 40 seconds.

10. The method according to claim 2, wherein the time T₁ for ultrasonic cleaning is between 10 seconds to 60 seconds.

11. The method according to claim 2, wherein the time Tₙ₊₂ for drying is between 5 seconds to 20 seconds.

12. The method according to claim 2, wherein the drying process is performed at 20-40° C.

13. A method for cleaning a wafer after a Chemical Mechanical Polishing (CMP) of the wafer, comprising: performing an ultrasonic cleaning on the wafer for time T₁; scrubbing the wafer for n times for time T₂, T₃, . . . , Tₙ₊₁ respectively, with n being an integer; drying the wafer for time Tₙ₊₂; wherein the maximum value among T₂, T₃, . . . , Tₙ₊₂ is Tₘₐₓ, wherein in the case of T₁<Tₘₐₓ, the ultrasonic cleaning process step comprises the following:
loading the wafer in an ultrasonic cleaning module and holding the wafer without the application of ultrasonic power for T′, with T′=Tₘₐₓ−T₁; and
then performing the ultrasonic cleaning on the wafer for time T₁.

14. The method according to claim 13, wherein the n is equal to or less than 3.

15. The method according to claim 13, wherein the values of time T₂, T₃, . . . , Tₙ₊₁ for scrubbing are between 5 seconds to 110 seconds.

16. The method according to claim 13, wherein the scrubbing of the wafer is assisted with a chemical agent and deionized water.

17. The method according to claim 16, wherein the wafer is scrubbed with the assistance of the chemical agent for a period between 0 seconds to 70 seconds, and then is scrubbed with the assistance of the deionized water for a period between 5 seconds to 40 seconds.

18. The method according to claim 13, wherein the time T₁ for ultrasonic cleaning is between 10 seconds to 60 seconds.

19. The method according to claim 13, wherein the time Tₙ₊₂ for drying is between 5 seconds to 20 seconds.

20. The method according to claim 13, wherein the drying process is performed at 20-40° C.

21. The method according to claim 14, wherein the values of time T₂, T₃, . . . , Tₙ₊₁ for scrubbing are between 5 seconds to 110 seconds.

22. The method according to claim 14, wherein the scrubbing of the wafer is assisted with a chemical agent and deionized water.

23. The method according to claim 22, wherein the wafer is scrubbed with the assistance of the chemical agent for a period between 0 seconds to 70 seconds, and then is scrubbed with the assistance of the deionized water for a period between 5 seconds to 40 seconds.

24. The method according to claim 14, wherein the time T₁ for ultrasonic cleaning is between 10 seconds to 60 seconds.

25. The method according to claim 14, wherein the time Tₙ₊₂ for drying is between 5 seconds to 20 seconds.

26. The method according to claim 14, wherein the drying process is performed at 20-40° C.
